(19) United States
(12) Patent Application Publication
(10) Pub. No.: US 2013/0179301 A1
(43) Pub. Date: Jul. 11, 2013

(54) COMPUTERIZED REAL ESTATE MARKETING SYSTEM

(71) Applicant: Mir Jafer Joffrey, Oak Park, IL (US)

(72) Inventor: Mir Jafer Joffrey, Oak Park, IL (US)

(21) Appl. No.: 13/734,797

(22) Filed: Jan. 4, 2013

Related U.S. Application Data
(60) Provisional application No. 61/583,985, filed on Jan. 6, 2012.

(51) Int. Cl. G06Q 30/06; G06Q 50/16

(52) U.S. Cl. CPC G06Q 30/0613; G06Q 50/16
USPC 705/26.41; 705/38

(57) ABSTRACT

A computerized real estate marketing that assists a buyer having available assets locate property to purchase. A computer executes application software that causes the computer to implement a database and a communication dataport. The database includes an entry for the qualified buyer and a description of the real estate the qualified buyer wants to purchase. The computer then markets the qualified buyer to real estate sellers. A seller supplies seller information with the seller information containing a description of property that the seller wishes to sell to the qualified buyer. The computer filters the seller information to determine if the seller property matches the described real estate. If it does the computer causes the qualified buyer to be informed about the seller property.

### RELATIONSHIP TO OTHER APPLICATIONS

The present application claims priority to and the benefit of U.S. provisional application No. 61/583,985, filed 6 Jan. 2012, and is also related to U.S. provisional application application No. 61/583,859, filed 6 Jan. 2012, both of which are hereby incorporated by reference in full, for all allowable purposes.

### FIELD OF THE INVENTION

The presently disclosed subject matter is directed towards methods of marketing real estate. More specifically, the present invention is directed to computerized methods of marketing real estate to buyers having readily available assets such as cash, cash equivalents, or pre-approved loans.

### BACKGROUND OF THE INVENTION

Modern finance has recently undergone a series of shocks that have stressed capital markets almost to the breaking point. Asset bubbles, defaults, bankruptcies, over-leveraged financial institutions, bailouts, foreign government defaults, and US government downgrades continue to dramatically impact the financial and nonfinancial world. Nowhere are these problems more apparent then in real estate. The so called “real estate bubble” caused serious and on-going damage to many areas of the United States.

Financing represents a wide family of complex business activities for originating, evaluating, granting, marketing, guaranteeing, and managing loans. As the ready availability of financing remains essential for America's economic well being, the smooth operation of the complex business activities that comprise modern financing is of utmost import. Because of the cost of the average American home many real estate activities involve some type of financing. Because of the importance of real estate financing some banks offer “pre-approved” loans in which a borrower is approved for a loan before they have chosen real estate to purchase, subject to final bank approval on the value of the real estate. This enables some real estate buyer to know how much they can spend on a home, saving a great deal of time, trouble, and aggravation.

The complex business activities of real estate finance are performed by an interdependent set of financial networks that are each comprised of numerous players. There are borrowers who wish to buy real estate, sellers who wish to sell real estate, and agents who assist the buying and selling. There are real estate financers and refinancers such as commercial banks, savings and loan associations, and credit unions that wish to make profitable real estate financing loans. There are secondary buyers of real estate loans. There are title companies that guarantee good title to the real estate being bought, and there are insurance companies that insure the property. There are US government organizations that are heavily involved in real estate such the Federal Housing Authority (FHA), Veteran's Administration (VA), the Federal Home Loan Mortgage Corporation (FHLMC), commonly known as Freddie Mac, the Federal National Mortgage Association (FNMA), commonly known as Fannie Mae Then there are a whole host of auxiliary financial players such as national credit rating agencies, insurers, marketers, secondary market lenders, loan packagers, collectors, asset evaluators, lawyers, and judges that make real estate markets run smoother.

Real estate is available over a very large range of prices. Run down homes in “bad” neighborhoods can be bought relatively cheaply, say less than $10,000, while spacious mansions in highly sought after locations can easily cost millions of dollars. But, in general, real estate purchasing is heavily dependent on the availability of relatively large amounts of money. While many people may want a very nice home in a good community, far fewer can actually afford such a home.

Various auction models have been developed for assisting the marketing of real estate. Those models typically use the ready availability, power, and speed of computers and the internet. For example, LendingTree.com™ has developed a method of financing secured loans in which a potential borrower's information is shared with numerous lending institutions so that those institutions can “compete” to give a loan to that potential borrower, thus enabling competition that may help that borrower obtain better loan terms. Typically the successful lender pays a fee for finding the borrower. Another example of auction real estate sales are Ebay® and other on-line sales sites where real estate is auctioned off to the highest bidder. Typically such real estate sale auctions are only used after the real estate has not sold in the normal real estate marketplace.

In some situations the LendingTree.com™ type model is very useful to buyers and sellers as it assists buyers in obtaining financing. However, some buyers have money readily available to purchase real estate, either because they have the money personally available, such as a cash buyer, or they have been “pre-approved” for a loan. In a buyer's market having readily available money is a major advantage as there are often sellers who will reduce the asking price to make a quick, sure sale. In such cases the LendingTree.com™ model has little utility while the Ebay® model suffers from poor focus because such auctions are usually used only with real estate that for some reason has not sold in the normal marketplace.

Despite the in-roads made by powerful computerized real estate auction systems, the majority of real estate is handled in the traditional manner. A seller attempts to sell real estate he owns, either by selling it himself or with the aid of a real estate broker or agent. The real estate is advertised in the newspaper, on the internet, in real estate magazines or brochures, or in multiple listing books published by various real estate sales organizations. The real estate is described and the sales price is provided, either in the advertisement or by a contact person. An interested buyer looks at the property and if interested in purchasing the property accepts the price or makes a counter-offer.

Like the real estate auction system the traditional manner of selling real estate is poorly focused. A buyer with readily available assets must wade through a large amount of sales material, much of which is not of interest to him, to find a suitable property to purchase. The asking price is often higher than the seller will actually accept so the buyer has to make counter-offers and look at real estate outside of his price range, just in case the seller will reduce the price to his range. The seller usually cannot afford to simply reduce the asking price to enable a quick sale because the seller cannot actually know that a particular buyer has readily available assets to make a quick sale. If a seller does reduce the asking price to obtain a quick sale that reduced asking price will tend to be the highest price any buyer will agree to pay, quick sale or not.

Therefore, a computerized method of assisting marketing of real estate to buyers having readily available assets would be beneficial. Even more useful would be a computerized method of marketing real estate to buyers having readily available and predetermined assets. Preferably such a computerized method of marketing real estate would focus on buyers having predetermined assets, who can make a quick purchase, and who have shown an interest in buying real estate.

### BRIEF SUMMARY OF THE INVENTION

The principles of the present invention provide for a computerized method of marketing real estate to buyers with ready availability of money to purchase real estate. Beneficially those principles are implemented in a computerized method of marketing real estate to buyers having predetermined assets. Preferably those principles are implemented in a computerized method of marketing real estate to buyers having predetermined assets, who can make a quick sale, and who have shown an interest in buying real estate. Beneficially the computerized method of marketing real estate would enable a buyer to be pre-approved for a loan if that buyer is not already pre-approved or if that buyer does not have money readily available to purchase real estate.

A computerized real estate marketing system according to the principles of the present invention assists a buyer having readily available assets locate property to purchase. A computer executes application software that causes the computer to implement a database and a communication dataport. The database includes an entry for the qualified buyer and a description of the real estate the qualified buyer wants to purchase, where that description includes price information. The application software enables the computer to market the qualified buyer to real estate sellers over the dataport. A seller supplies seller information over the dataport, with the seller information containing a description of property that the seller wishes to sell to the qualified buyer. The computer filters the seller information to determine if the seller property matches the described real estate. If it does the computer causes the qualified buyer to be informed about the seller property.

Beneficially, the readily available assets are verified prior to marketing. Readily available assets can include a pre-approved loan or cash. The described real estate should include a desired location. Sellers can pre-join the real estate marketing system and enter information about their property into the database. The computer can then search the database to find a match between the desired property and the seller entry. Preferably the price information includes a maximum price. Seller information can be supplied by a real estate broker of a real estate marketer.

### BRIEF DESCRIPTION OF THE DRAWINGS

The advantages and features of the present invention will become better understood with reference to the following detailed description and claims when taken in conjunction with the accompanying drawings in which:

FIG. 1 presents the network topology of a computerized real estate marketing system 10 that is in accord with the principles of the present invention;

FIG. 2 illustrates a prototypical database 20 used in the computerized real estate marketing system 10;

FIG. 3A is a flow chart depicting part of the operation 200 of the computerized real estate marketing system 10;

FIG. 3B is a flow chart depicting another part of the operation 200 of the computerized real estate marketing system 10;

FIG. 4 presents the network topology of an alternative computerized real estate marketing system 400 that is in accord with the principles of the present invention and in which a potential buyer seeks pre-approval for a loan;

FIG. 5A is a flow chart depicting part of the operation 500 of the computerized real estate marketing system 400; and

FIG. 5B is a flow chart depicting another part of the operation 500 of the computerized real estate marketing system 400.

### DETAILED DESCRIPTION OF THE INVENTION

The presently disclosed subject matter will be described more fully hereinafter with reference to the accompanying drawings in which one embodiment is shown. However, it should be understood that this invention may take many different forms and thus should not be construed as being limited to the specific embodiment set forth herein.

In the figures like numbers refer to like elements throughout. Additionally, the terms “a” and “an” herein do not denote a limitation of quantity, but rather denote the presence of at least one of the referenced items. All documents and references referred to in this document are hereby incorporated by reference for all purposes.

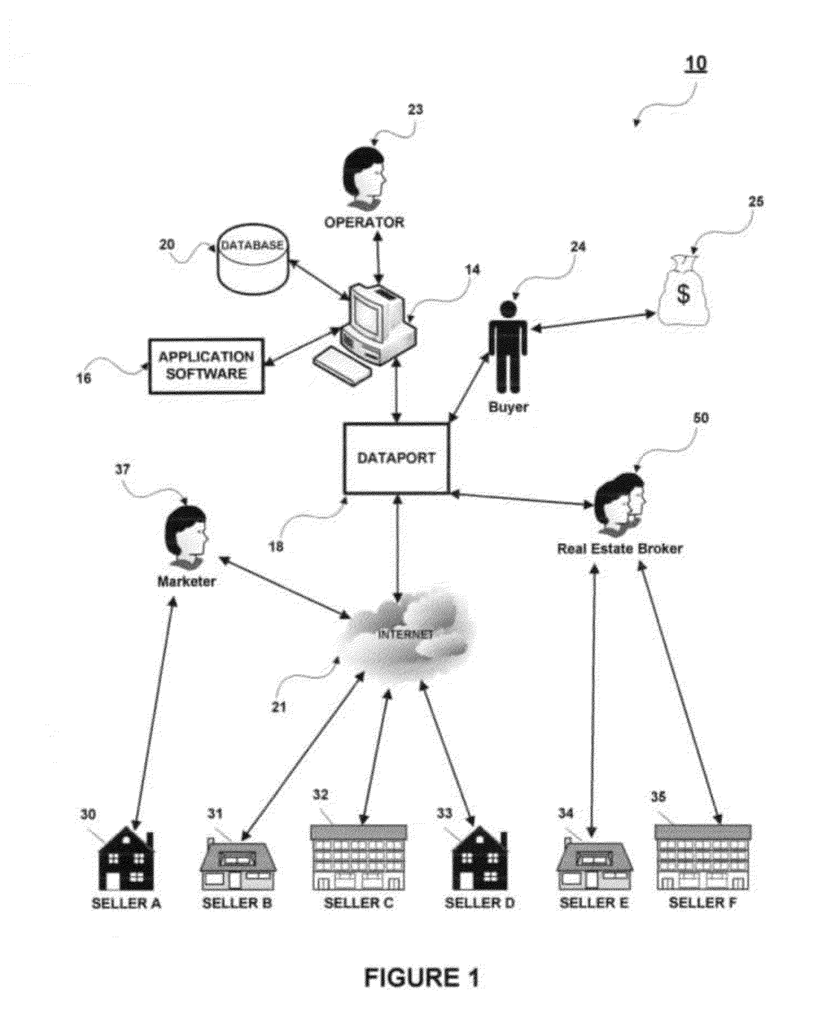

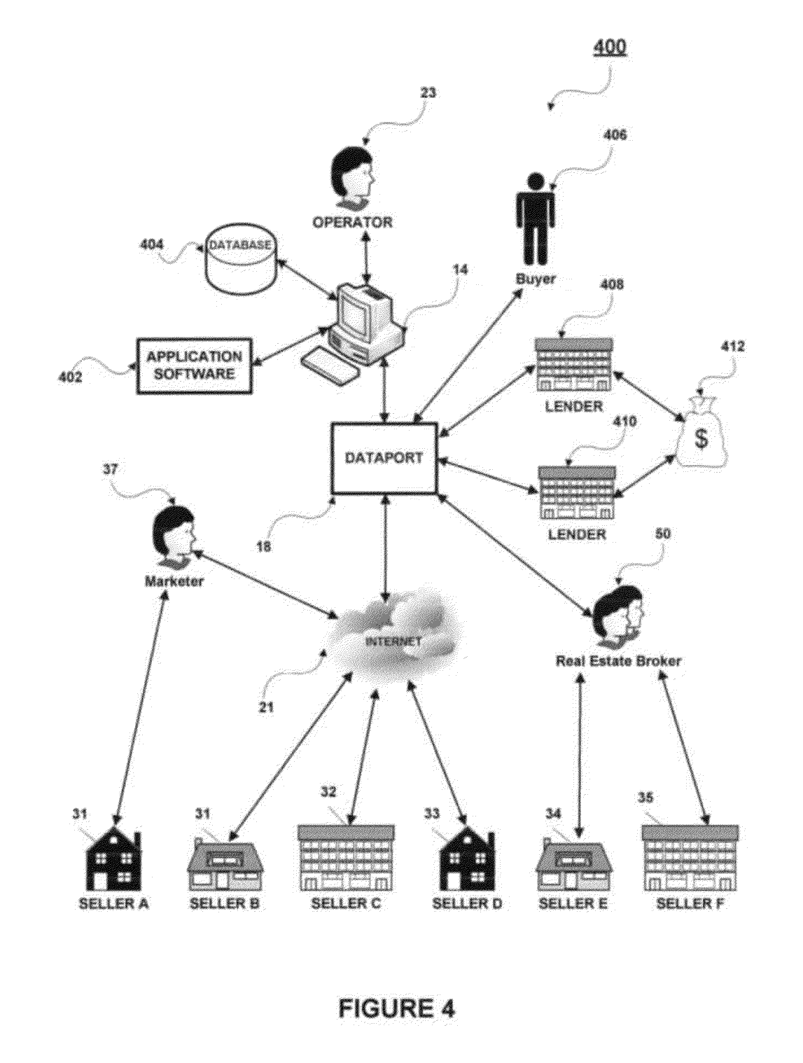

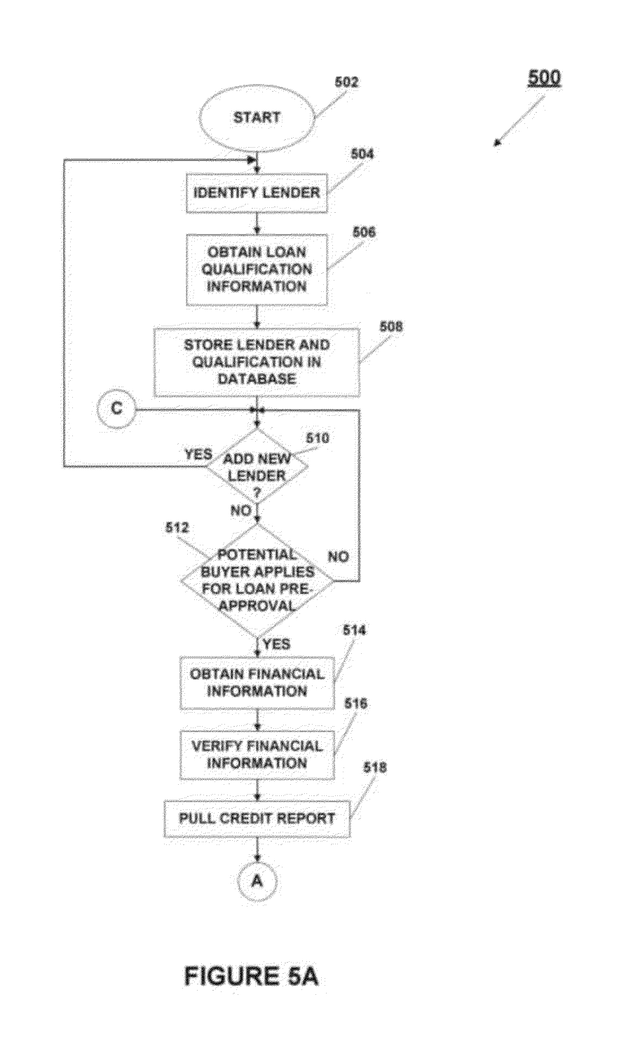

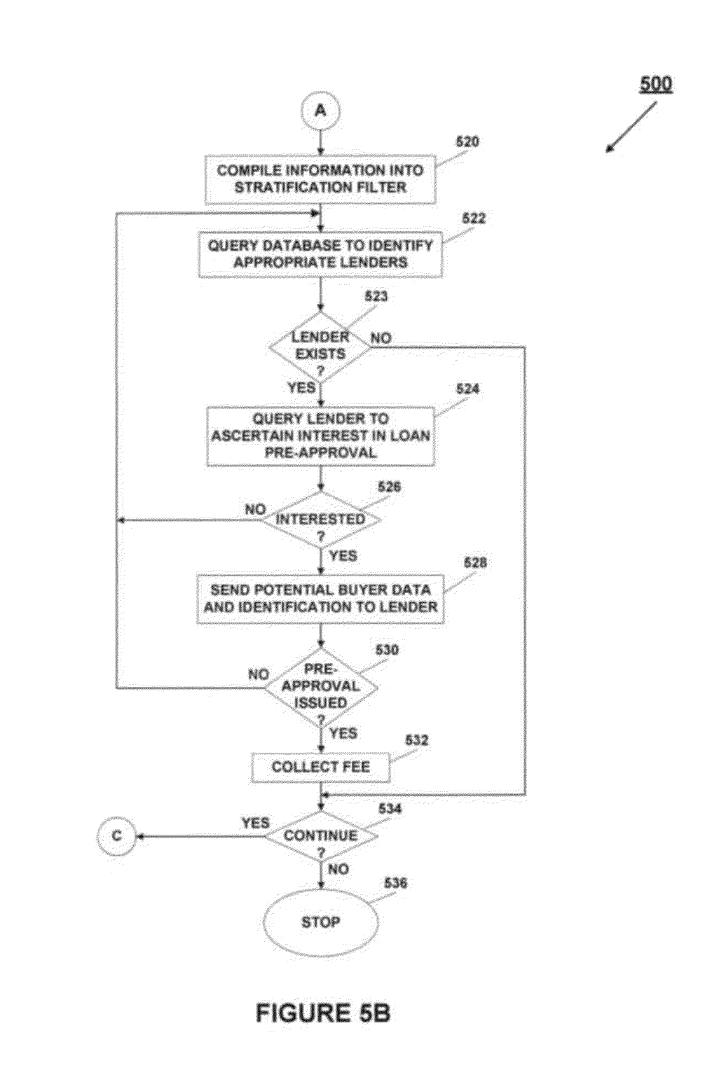

The principles of the present invention are implemented in a computerized real estate marketing system 10 depicted in FIGS. 1 through 3B and in an alternative computerized real estate marketing system 400 depicted in FIGS. 4 through 5B. Those principles enable focused marketing of real estate to buyers having readily available assets or financing such as being pre-approved for a loan or available cash. Those principles enable sellers to specifically target their property to suitable buyers and for suitable buyers to be better able to evaluate available property in their price range. In practice the principles of the present invention flip the prior art market concept of “I have this house for sale for this amount of money” to “I have this amount of money readily available for real estate.”

As shown in FIG. 1, the computerized real estate marketing system 10 includes a computer 14 that executes application software 16. The Application Software 16 causes the computer 14 to implement a dataport 18 and a database 20. The dataport 18 enables the computer 14 to access remote entities (see below) over telephone lines, wireless communication networks, and most beneficially over the internet 21. Thus the dataport 18 should be understood as generically representing a port handling as many different communication mediums as required to enable communications with all entities of interest. The database 20 is explained in more detail subsequently.

To understand the computerized real estate marketing system 10 it should be understood that a real estate buyer 24 is looking to buy real estate using a ready source of money 25 to make the purchase. That ready source of money 25 might be money in a bank account, cash, a pre-approved credit line, stocks, bonds, gold, silver, or any other money equivalent. Beneficially the buyer 24 communicates his desire to participate in the computerized real estate marketing system 10 by contacting an operator 23 of the computerized real estate marketing system 10 over the dataport 18. That buyer 24 will identify themselves and notify the computerized real estate marketing system 10 that they wish to purchase real estate costing between a lower limit and an upper limit.

Additionally, various sellers A-F (30-35) having real estate that they wish to sell have also indicated their interests in participating in the computerized real estate marketing system 10. At least some of sellers A-F (30-35) hopefully have real estate priced between the lower limit and the upper limit. Some of the sellers, in FIG. 1 the sellers E and F (34-35), use a real estate broker 50 to assist them in selling their properties, while others, in FIG. 1 the sellers A-D (30-33) do not. However, seller A 30 uses a marketer 37 that participates in the computerized real estate marketing system 10 by attempting to find a seller, such as seller A 30, who is not directly a member of the computerized real estate marketing system 10 but who has property that the buyer 24 might be interested in.

Still referring to FIG. 1, some of the parties, such as the sellers B-D (31-33) and the marketer 37 in FIG. 1, may make use of the internet 21 to communicate with the computer 14 via the dataport 18. Other parties, such as the real estate broker 50 in FIG. 1, may use other forms of communication such as phone lines, regular mail, personal contact, etc.

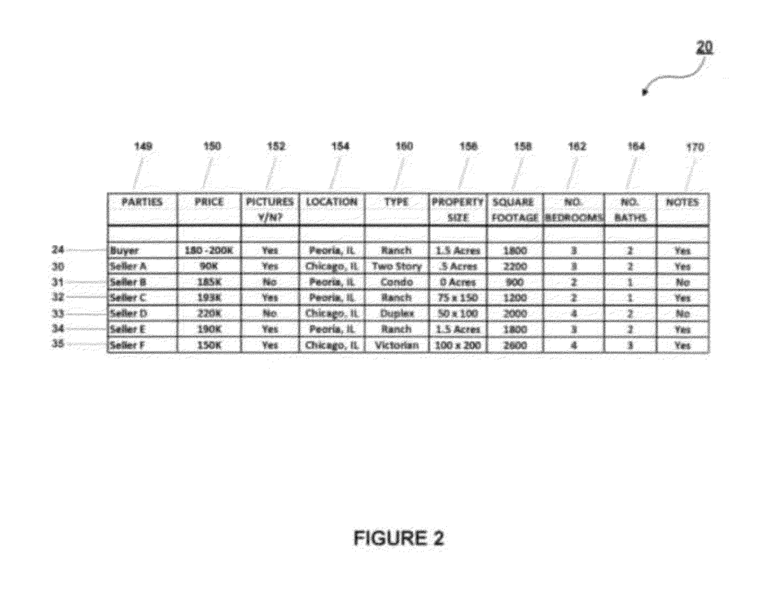

The computerized real estate marketing system 10 makes extensive use of the database 20. FIG. 2 illustrates the contents of a prototypical database 20. The database 20 includes a list of parties 149 who are participating, either directly or indirectly, in the computerized real estate marketing system 10. Those parties 149 include the buyer 24, the seller A 30 via the marketer 37, and the sellers 37-F (30-35). The database 20 also includes the price 150 of either a particular real estate property or the price range that the buyer 24 is interested in. Some properties will include pictures 152 to assist the buyer 24 in considering a particular real estate property. In addition, the buyer 24 may only be willing to consider properties having pictures (denoted by “Yes” for the buyer 24 in column 152).

The database 20 will also include various elements that can be used as filters to help the buyer 24 sort through various offerings so that he does not have to consider property he is not interested in. To that end the buyer 24 provides information as to the location 154 of the real estate he is interested in purchasing, the type 160 of property he is looking for, the property size he seeks, the minimum square footage 158 of the house on the property he wants, as well as the number of bedrooms 162 and the number of baths 164. Many other types of information may also be included in the database 20.

Furthermore, each of the sellers A-F (30-35) supplies the sales price 150 of their properties. Additionally, the sellers A-F (30-35) supply pictures 152, the location 154, the property type 160, the property size 156, the square footage 158, the number of bedrooms 162, and the number of baths 164 for the property they are trying to sell. Additional information such as sales histories, historical prices, comparables, and any other information a seller A-F (30-35) or marketer 37 may wish to convey may be added to the database 20 as notes 170. The database 20 is flexible enough to allow the same seller to market several properties and the same buyer 24 to look to buy multiple properties.

Referring once again to FIG. 1, the buyer 24 causes the computer 14 to search the database 20 and to notify other sellers over the dataport 18 to identify real estate that is priced between his lower and upper limits and in the location and with the features he is interested in purchasing.

If the buyer 24 does not find a property of interest his purchase profile remains in the database 20 awaiting other properties that he might be interested in. To that end the buyer 24 receives solicitations to buy property. As potential sellers know that they are dealing with a fully qualified buyer they may wish to lower their price or to take other action to induce the buyer 24 to purchase their property. The prior art listing of properties to buy for money is flipped around to list money available for property. Potential sellers benefit because they are targeting the sale of their property to qualified buyers while buyers benefit because sellers may make properties with asking prices outside of their purchasing interest available to them by lowering the asking price.

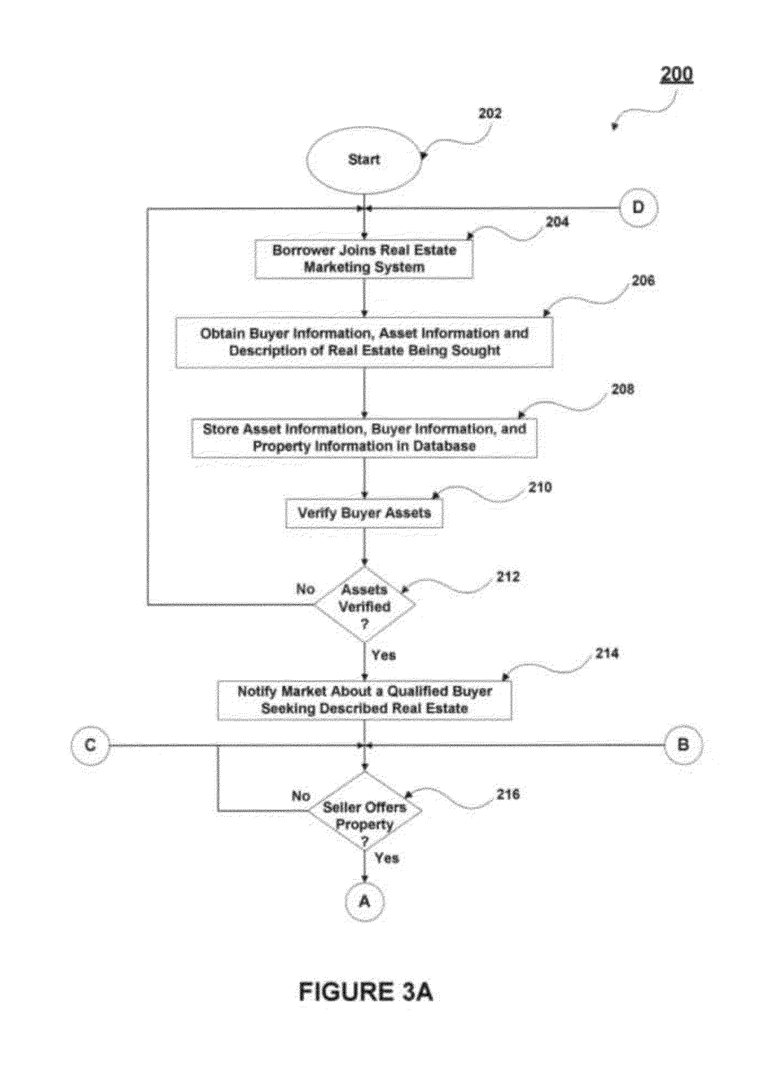

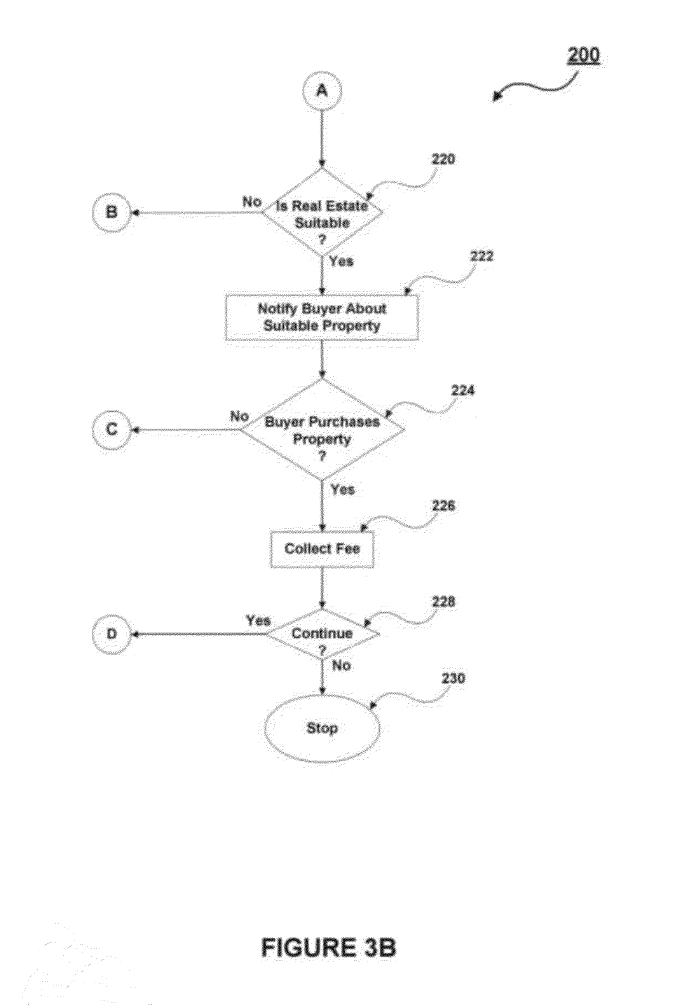

FIG. 3 presents a flow diagram of the operation 200 of the computerized real estate marketing system 10. The operation 200 starts, step 202 and proceeds with a buyer 24 who is looking to purchase real estate joining the computerized real estate marketing system 10, step 204. The computerized real estate marketing system 10 then obtains information about the buyer 24, including his address, contact information (such as email address and web address), information about his assets 25, and a description of the real estate the buyer 24 wants to purchase, step 206. The buyer information, asset information and property information is then stored in the database 20, step 208.

As the computerized real estate marketing system 10 is directed at buyers having readily available assets, the computerized real estate marketing system 10 verifies the buyer's assets, step 210. For example, the operator 23 may contact a bank to verify pre-approval of a loan or the buyer's assets in a bank account. A third party asset verifier may be enlisted as required. If the assets cannot be verified, or if the assets are not readily available, the computerized real estate marketing system 10 returns to step 204 to await a suitable buyer, step 212. However, if in step 212 the assets of the buyer 24 are verified as both existing and as being readily available, the operation 200 proceeds to step 214 where a market is notified about a qualified buyer 24 seeking described real estate. That market is comprised of real estate owners, such as the sellers A-F (30-35) real estate brokers 50, or marketers 37 wishing to sell property identical to or very similar to the real estate described by the buyer 24.

The step 214 of notifying the market should be understood as including searching the database 20 to identify sellers who have already listed property on the computerized real estate marketing system 10 that is identical to or very similar to the described real estate. After being identified, the computerized real estate marketing system 10 will automatically notify them about the buyer 24 and the real estate he is looking for. Thus the sellers A-F (30-35) “pre-register” their properties with the computerized real estate marketing system 10. Thus notifying the market includes marketing the buyer 24 to those outside of the computerized real estate marketing system 10 and to those who are all ready members of the computerized real estate marketing system 10.

Step 214 is performed based on real estate for sale that is either identical to or very similar to the described real estate. “Similar to” implies that the computerized real estate marketing system 10 will go somewhat beyond the specific real estate description to include properties that either might be brought into exact accord with the described property or which might be so similar to the described property that a buyer may wish to consider them. For example, if the described property is priced between $180,000 and $200,000, a seller having a property with an asking price of $210,000 might wish to reduce the price to $200,000 to induce a sale. As another example, if the property is described as being more than 2 acres a property of 1.75 acres might still be of interest. Experience will be used to better define “similar.”

After the market is notified about a qualified buyer 24 looking for described real estate, step 214, the computerized real estate marketing system 10 waits for a seller to offer property to the buyer, step 216. If a seller does not offer property the computerized real estate marketing system 10 loops until one does. However, once a seller offers property to the buyer 24 the operation 200 proceeds with the computerized real estate marketing system 10 determining if the real estate being offered is suitable, step 220. This step is to protect the buyer 24 from having to consider unsuitable properties. Step 220 requires the seller to enter information to the computer so that the computer can search the information in the database 20 about the desired real estate.

If the property offered in step 216 is not suitable the operation 200 returns to step 216 to wait for another seller to offer property, step 220. However, if the property offered is suitable the operation proceeds from step 220 to notifying the buyer 24 about the suitable property, step 222. The buyer 24 then decides whether or not to purchase the suitable property, step 224. If the buyer declines to purchase the property the operation 200 returns to step 216 to await another seller offering suitable property.

But, if in step 224 the buyer decides to acquire the property the operation 200 proceeds to step 226 where the operator 23 of the computerized real estate marketing system 10 collects a fee for their marketing assistance. The fee might be paid by the seller, by the buyer 24, or by both. It should be understood that the marketing fee does not have to be paid upon the sale of property. A fee might be charged when the buyer 24 joins the computerized real estate marketing system 10, when a seller decides to participate, or at some other time.

A decision is then made to continue with the operation 200 of the computerized real estate marketing system 10, step 228. If yes (as it will almost always be) the operation 200 returns to step 204 to await a buyer joining the computerized real estate marketing system 10. Otherwise the operation 200 stops, step 230.

The foregoing has described a computerized real estate marketing system 10 in which a real estate buyer 24 has readily available assets to purchase real estate. In some instances a potential buyer 406 may qualify for pre-approval on a real estate loan but may not have yet obtained such pre-approval. While the computerized real estate marketing system 10 is not suitable for such a potential buyer 406, FIG. 4 illustrates a computerized real estate marketing system 400 that is suitable.

The computerized real estate marketing system 400 attempts to either pre-approve or obtain pre-approval of a potential buyer 406 before marketing real estate for him/her. The computerized real estate marketing system 400 may be operated by a bank or other real estate financing entity, by a loan marketing agency, or by a real estate marketing agency.

Referring now to FIG. 4, the computerized real estate marketing system 400 includes a computer 14 that executes application software 402. The application software 402 causes the computer 14 to implement a dataport 18 and a database 404. The dataport 18 enables the computer 14 to access remote entities (see below) over telephone lines, wireless communication networks, and most beneficially over the internet 21. Thus the dataport 18 should be understood as generically representing a port handling as many different communication mediums as required to enable communications with all entities of interest. The database 404 preferably includes all of the entries of the database 20 used in the computerized real estate marketing system 10, but further includes information required to assist pre-approval of a potential buyer 24.

The computerized real estate marketing system 400 includes at least one lender 408 that issues pre-approvals for real estate purchase loans. It should be understood that the lender 408 may be operating the computerized real estate marketing system 400. However, if the lender 408 is not operating the computerized real estate marketing system 400 it is beneficial to have at least one or more participating lenders 410. The more lenders the better the computerized real estate marketing system 400 can work for the potential buyer 406.

In any event the lenders 408 and/or 410 can pre-approve access to money 412 that is available to lend to the potential buyer 406 to purchases real estate. The lenders 408 and 410 may have different loan criteria and they may have different loan rates and terms. For example, the lender 408 may have the best financing terms, but might require that to obtain loan pre-approval that the potential buyer 406 needs a credit score above 90 (ratings being taken from 0, the worst, to 100, the best). Lender 410 might have less favorable terms but might be willing to pre-approve a loan to the potential buyer 406 if he has a credit rating above 86.

The database 404 beneficially includes a listing for each of the lenders 408, 410 participating in the computerized real estate marketing system 400, along with the credit score or other credit benchmark that each lender requires to issue pre-approval of a real estate loan. Other data associated with each lender can also be in the database 404, for example, the minimum income and assets that each lender wants a borrower to have to obtain loan pre-approval, along with the interest rates, terms, and minimum and maximum loans it will consider. Those are examples only and other terms and criteria will almost certainly be included in actual implementations of the database 404. Furthermore, the database 404 is flexible enough to allow the same lender to have multiple entries, such as a credit rating of 85 will correspond to 5% interest while a credit rating of 50 will correspond to 12% interest and so on. Thus the database 404 contains sufficient information to allow the computer 14 to search and find lenders, such as the lenders 408, 410, willing to provide pre-approvals for real estate loans and the conditions under which they are willing to do so.

The computerized real estate marketing system 400 then gathers information from the potential buyer 406 regarding the desired pre-approval amount, their income, their sources of income, their assets, their debts, their monthly payments, and other pertinent information for granting pre-approval as well as such items as mailing address, email address, social security number, and references. Then, the computerized real estate marketing system 400 obtains a credit report or other credit benchmark for the potential buyer 406. Such a credit benchmark is useful for determining which lender is best suited to grant loan pre-approval.

If a lending institution runs the computerized real estate marketing system 400 that lending institution could decide whether to pre-approve the potential buyer 406 for a real estate loan. Alternatively, the computerized real estate marketing system 400 can have the computer 14 search the database 404 to identify one or more lenders 408, 410 who have shown an interest in pre-approving real estate loans to borrowers similarly situated as the potential buyer 406.

If one or more suitable lenders 408, 410 are found the lender(s) with the best available terms, say lender 408 is provided with specific information about the potential buyer 406 (pre-approval amount sought, income, sources, of income, assets, debts, monthly payments) and is queried as to whether they are interested in making the sought after loan to a person similarly situated as the potential buyer 406. If so, the lender 408, 410 is provided with contact information for the potential buyer (name, address, social security information) and a pre-approval application is completed.

If pre-approval is obtained the computerized real estate marketing system 400 operates in the same manner as the computerized real estate marketing system 10. If not, another lender is queried as to whether they are interested in making the sought after loan pre-approval to a person similarly situated as the potential buyer 406. If a lender cannot be found, the computerized real estate marketing system 400 notifies the potential buyer that he does not qualify to participate in the system.

FIGS. 5A and 5B presents a flow diagram of the operation 500 of the loan pre-approval elements of the computerized real estate marketing system 400. The operation 500 starts, step 502 and proceeds with identifying at least one lender 408 (address, contact information, email address, web address, etc.) that is interested in participating in the computerized real estate marketing system 400, step 504. By participating, a lender 408 signifies that it is interested in granting loan pre-approvals of the specific type being handled by the computerized real estate marketing system 400.

After a lender 408 is identified, step 504, that lender 408 provides pre-approval qualification information to the computerized real estate marketing system 400, step 506. For example, a lender 408 might be required to supply the minimum credit rating it will consider for a pre-approval, the minimum borrower income required for a pre-approval, the minimum borrower assets required for pre-approval, the minimum and maximum pre-approvals it would be interested in granting, and typical loan terms such as interest rate and repayment periods. In practice a lender 408 might enter information numerous times for different loan conditions, such as a 5% interest rate with a credit rating of over 86, a 12% interest rate for a credit rating between 75 and 85, etc. The lender information (address, contact information, email address, web address, etc) together with the information that the lender supplied in step 506 is then caused to be stored by the computer 14 in the database 404, step 508.

After step 508 the database 404 contains information suitable for stratifying loan pre-approvals. That is, the database has sufficient information for the computer 14 to search the database 404 to find a lender 408 that may pre-approve a loan for the potential buyer 406. However, to better serve potential buyers the computerized real estate marketing system 400 continues to look for additional lenders 410. To do so, after step 508 a decision is made as to whether a new lender is to be added to the database 404, step 510. If yes, a loop is made back to step 504 so that the new lender 410 can be identified, their information obtained, and the database 404 updated.

However, if in step 510 a new lender is not to be added the computerized real estate marketing system 400 proceeds to step 512 to look for a potential buyer 406 that applies for a loan pre-approval. If there is no potential buyer 406 the operation 500 returns to step 510. A multistep loop is then entered wherein the computerized real estate marketing system 400 looks for a new lender or for a potential buyer 406, steps 510 and 512.

When a potential buyer 406 applies for loan pre-approval the computerized real estate marketing system 400 obtains financial information from the potential buyer 406, step 514. That information beneficially includes identification information for the potential buyer 406 such as their mailing address, email address, web address, and financial information such as income, amount of loan sought, the purpose of the loan, assets, credit and payment history, current and former employer, past loans, and possibly credit references.

After step 514 the computerized real estate marketing system 400 seeks to verify the information provided by the potential buyer 406, step 516. This step is optional, but useful to both the potential buyer 406 and to lenders 408, 410. In any event the computerized real estate marketing system 400 pulls the credit report of the potential buyer 406, step 518.

With the credit report available and with the information supplied by the potential buyer 406 available the computerized real estate marketing system 400 compiles all of that information to form a stratification filter, step 520. The computerized real estate marketing system 400 then uses the stratification filter as a template to query the database 404 to identify appropriate lenders 408, 410 willing to issue loan pre-approval to a borrower similarly situated as the potential buyer 406, step 522.

When performing step 522, the lenders that have indicated that they are not interested in granting loans to borrowers similarly situated to the potential buyer 406 are placed at the bottom of a lending queue. However, the lenders that have indicated that they are interested in issuing loan pre-approvals to borrowers similarly situated to potential buyer 406 are placed toward the top of the lending queue. Then, the lenders with the most favorable terms, such as loan duration and interest rates are sorted to be located higher in the lending queue.

It is possible that there is no lender that is interested in issuing a loan pre-approval to borrowers similarly situated to potential buyer 406. Therefore, if after step 522 there is no lender interested in issuing a loan pre-approval, the operation 500 passes to step 534, which is described in more detail subsequently, step 523. However, if computerized real estate marketing system 400 does identify a lender interested in pre-approving a loan to a borrower similarly situated to potential buyer 406 the operation 500 passes to step 524.

In step 524, the computerized real estate marketing system 400 queries the “best” of the stratified lenders 408, 410 to determine if they are actually interested in issuing a loan pre-approval to a borrower similarly situated as the potential buyer 406. The “best” lender then makes a decision as to whether they are interested in considering making the sought for loan pre-approval, step 526. If the “best” lender is not interested, another suitable lender is selected by returning to step 522, step 526.

However, if in step 526 a lender signifies interest in granting a loan pre-approval to a borrower similarly situated as the potential buyer 406, that lender is supplied with specific information about the potential buyer 406, step 528. Specifically, that lender is supplied with the potential buyer's 406 name, contact information, assets, income, the information on the application, and other available information. Step 528 is the first time that any lender is actually provided with specific information about the potential buyer 406. At all other times the computerized real estate marketing system 400 has been “pre-qualifying” the potential buyer 406.

The lender then decides whether to pre-approve a loan, step 530. If pre-approval is not approved, the operation 500 returns to step 522 for selection of another potential lender. However, if the loan is approved, the Operator 23 of the computerized real estate marketing system 400 collects a fee, step 532. A decision is then made as to whether to continue operating the computerized real estate marketing system 400, step 534. That same decision is made if in step 523 there is no lender interested in making a loan to a borrower similarly situated to potential buyer 406. If yes (as it will almost always be) the operation 500 returns to step 510. Otherwise the operation 500 stops, step 536.

It is to be understood that while the figures and the above description illustrate the present invention, they are exemplary only. They are not intended to be exhaustive or to limit the invention to the precise forms disclosed, and obviously many modifications and variations are possible in light of the above teaching. Others who are skilled in the applicable arts will recognize numerous modifications and adaptations of the illustrated embodiments that remain within the principles of the present invention. Therefore, the present invention is to be limited only by the appended claims.

What is claimed:

1. A computerized real estate marketing system for assisting a buyer locate property comprising a computer executing application software that causes said computer to implement a database and a communication dataport that are in functional communication with said computer;
wherein said database includes at least one entry for a qualified buyer having readily available assets who is seeking described real estate, said described real estate including price information;
wherein said readily available assets are verified prior to marketing of said qualified buyer;
and wherein said readily available assets include a pre-approved loan;
wherein said application software enables said computer to market said qualified buyer to real estate sellers over said dataport;
wherein said application software enables said dataport to provide said computer with seller information containing a description of seller property that a seller wishes to sell to said qualified buyer;
wherein said application software causes said computer to filter said seller information to determine if said seller property matches said described real estate; and
wherein said computer causes said qualified buyer to be informed of said seller property if said seller property matches said described real estate.

2. The computerized real estate marketing system according to claim 1, wherein said readily available assets is buyer money.

3. The computerized real estate marketing system according to claim 1, wherein said described real estate includes a desired location.

4. The computerized real estate marketing system according to claim 1, wherein said database includes an entry for at least one seller, and wherein said entry includes a description of property said at least one seller wishes to sell.

5. The computerized real estate marketing system according to claim 4, wherein computer searches said database to find a match between said desired property and said entry for said at least one seller.

6. The computerized real estate marketing system according to claim 1, wherein said price information includes a maximum price.

7. The computerized real estate marketing system according to claim 1, wherein said seller information is from a real estate broker.

8. The computerized real estate marketing system according to claim 1, wherein said seller information is from a real estate marketer.

9. A computerized method of marketing real estate comprising, in any order, the steps of:
(i) identifying a qualified buyer having readily available assets;
(ii) obtaining qualified buyer information about described real estate the qualified buyer wants to purchase, where the buyer information includes price information;
(iii) storing qualified buyer information in a computer database;
(iv) notifying the market about the qualified buyer seeking the described real estate;
(vii) obtaining information about property a seller wants to sell to the qualified buyer;
(viii) comparing seller information to the described real estate;
(ix) verifying the readily available assets of the qualified buyer prior to notifying the market about the qualified buyer; and
(x) notifying the qualified buyer about the seller information if the seller property matches the described real estate.

10. The computerized method of marketing real estate according to claim 9, wherein the readily available assets include a pre-approved loan.

11. The computerized method of marketing real estate according to claim 9, wherein the readily available assets include cash.

12. The computerized method of marketing real estate according to claim 9, wherein the described real estate includes a desired location.

13. The computerized method of marketing real estate according to claim 9, wherein the database includes an entry for at least one seller, and wherein that entry includes a description of property the at least one seller wishes to sell.

14. The computerized method of marketing real estate according to claim 13, wherein a computer searches the computer database to find a match between the desired property and the entry for the at least one seller.

15. The computerized method of marketing real estate according to claim 9, wherein the price information includes a maximum price.

16. The computerized method of marketing real estate according to claim 9, wherein the seller information is from a real estate broker.

17. The computerized method of marketing real estate according to claim 9, wherein the seller information is from a real estate marketer.

18. A computerized marketing real estate system for assisting a potential buyer obtain preapproval for a real estate loan, said system comprising a computer executing application software that causes said computer to implement a database and a communication dataport in functional communication with said computer;
wherein said database includes at least one loan term and a credit benchmark required for loan preapproval for each potential lender of a plurality of potential lenders;
wherein said application software enables said computer to obtain application information over said dataport from the potential buyer;
wherein said application software causes said computer to obtain a credit benchmark for the potential buyer;
wherein said application software causes said computer to search the database to identify potential lenders that will consider pre-approving a real estate loan to a potential buyer having said potential buyer's credit benchmark;
stratifying said identified potential lenders according to said at least one loan term into a hierarchy of potential lender to identify a best potential lender for the potential buyer; and
wherein said best potential lender is queried as to whether they are interested in pre-approving a loan to a potential borrower having said potential buyer's credit benchmark.

19. A computerized marketing real estate system according to claim 18, wherein said application software causes said computer to add said potential buyer to said database as a qualified buyer upon a lender pre-approving said potential buyer.

20. A computerized marketing real estate system according to claim 19, wherein said database further includes entries regarding available assets and described real estate for said qualified buyer, said described real estate including price information;
wherein said application software enables said computer to market said qualified buyer to real estate sellers over said dataport;
wherein said application software enables said dataport to provide said computer with seller information containing a description of seller property that a seller wishes to sell to said qualified buyer;
wherein said application software causes said computer to filter said seller information to determine if said seller property matches said described real estate; and
wherein said computer causes said qualified buyer to be informed of said seller property if said seller property matches said described real estate.
